(19) United States
(12) Patent Application Publication
(10) Pub. No.: US 2013/0263793 A1
(43) Pub. Date: Oct. 10, 2013

(54) NUCLEUS COVERED WITH PHA

(71) Applicants: Jean Guezennec, Plouzane (FR); Christelle Simon-Colin, Guilers (FR); Achraf Kouzayha, Kalamoun (LB); Evelyne Bachere, Sainte Croix Vallee Francaise (FR)

(72) Inventors: Jean Guezennec, Plouzane (FR); Christelle Simon-Colin, Guilers (FR); Achraf Kouzayha, Kalamoun (LB); Evelyne Bachere, Sainte Croix Vallee Francaise (FR)

(73) Assignee: DIRECTION DES RESSOURCES MARINES, Papeele (FR)

(21) Appl. No.: 13/993,863

(22) PCT Filed: Dec. 14, 2011
(86) PCT No.: PCT/FR2011/052987

§ 371 Date: Jun. 13, 2013

(30) Foreign Application Priority Data
Dec. 14, 2010 (FR) 1060461

(51) Int. Cl. A01K 61/00

(52) U.S. Cl. CPC A01K 61/002
USPC 119/244; 560/185; 106/287.24; 106/18.32; 800/8; 427/212

(57) ABSTRACT

The present invention relates to a nucleus covered or coated with a film including one or more PHA. The invention also relates to a PHA, characterized in that it is of the type PHB-V, a film and a composition including the PHA. The invention further relates to a film or a composition including a PHA and zosteric acid or a bioactive molecule. The invention moreover relates to a surface, preferably a nucleus, covered with the film of PHA, a method for production thereof, and methods for grafting a pearl oyster and producing a pearl using this nucleus. Finally, the present invention relates to a method for reducing graft failure and/or for improving the quality of the pearl using the nucleus according to the invention.

### FIELD OF THE INVENTION

The present invention relates to the field of coating nuclei in the context of pearl farming (pearl production by pearl oysters). The present invention thus relates to a nucleus coated with an homogenous film having antibacterial properties, and enabling to improvement of the quality of the pearl obtained and reducing the mortality following the insertion of said nucleus into the recipient pearl oyster and the nucleus rejection phenomenon.

### PRIOR ART

Pearl farming is a human activity consisting in cultivating, in a natural environment, Pinctada sp pearl oysters in order to produce cultured pearls. The first step relates to the collection and breeding of the pearl oysters to be used either as donor oysters or as recipient oysters. Grafting consists of the surgical operation during which the graft, a portion of the epithelium of the donor oyster mantle (approximately 4 mm²) is inserted into the gonad of the recipient oyster, in combination with a nacre bead, the nucleus. Once inserted into the recipient oyster, the epithelial edge of the graft multiplies and covers up the gonad to produce the pearl sac coating the nucleus. Said pearl sac deposits layers of nacre around the nucleus, resulting in the production of the pearl (Montagnani et al., 2009 Chembiochem. 2011 Sep. 5; 12(13):2033-43). To ensure high-quality pearl production, the surface of the nucleus should be as regular as possible, with no irregularities.

Mortalities and nucleus rejections occur during approximately 45 days post-graft, at variable rates. These phenomena, affecting 40 to 50% of oysters within the three weeks following the surgery, seem to result from infectious diseases, or from an unsuitable grafting technique. The development of an inflammatory reaction following the insertion of the nucleus, and the contamination by pathogenic bacteria combined with the lack of rapid healing of the incised tissues during the graft, are probably the main causes of nucleus rejection (Cochennec et al., 2010).

Therefore, there is a need for methods resulting in a reduction in the grafting operation failure rate, particularly resulting in the reduction mortality and nucleus rejection, while ensuring premium quality pearl production.

The patent application JP05219856 describes the insertion into the recipient oyster, during the grafting phase and in parallel with the nucleus or by means of the nucleus, of a solid material containing on the surface thereof a water-soluble polymer associated with an antibiotic.

The Japanese patent application JP02308869 claims the use of a nucleus coated with a synthetic polymer associated to an antifouling agent for particularly enhancing the quality of the pearls obtained, by increasing the homogeneity of the nucleus surface, and for reducing rejection and mortality phenomena, preventing the colonisation of the nucleus by various parasites, for example.

The U.S. Pat. No. 6,514,614 describes the coating of the nucleus by a water-soluble polymer, associated to a substance having an antibacterial activity, said polymer being partially dissolved by seawater (the dissolution rate being greater than 25%) for effectively reducing frictions and resistance to the insertion of said nucleus.

Finally, the Japanese patent application JP03183424 describes a system for coating the nucleus with a water-soluble polymer (or with any other compounds enabling deferred administration), for administering an antibiotic associated to said polymer at a controlled rate.

However, the solutions suggested in the publications cited above, pose an environmental problem, due to the lack of or incomplete biodegradability of the elements used, whether they consist of synthetic coating agents or antibiotics. Moreover, the use of antibiotics also poses a public health problem, via the development of bacterial resistances. Finally, the use of water-soluble polymers gives rise to a limitation of the action of these compounds over time, with a progressive disappearance of the coating compound following the immersion of the oysters in the aqueous medium.

Surprisingly, the inventor observed that coating the nucleus with a film of polyhydroxyalkanoate (PHA), a natural, biodegradable and non-water-soluble polymer reduces the failure rate of grafting operations, and improves the quality of the pearls obtained.

Without willing to be bound to any theory, the inventors suggest that coating the nucleus with a PHA film would enhance the homogenisation of the nucleus surface, thus limiting the presence of surface irregularities on the pearl. Moreover, the PHA could limit the adhesion of bacteria onto the nucleus, and bacterial growth. This intrinsic effect of PHAs, coupled with the association of said PHA film with bactericidal or bacteriostatic agents, such as for example antimicrobial peptides (AMP), would thus reduce the occurrence of microbial contaminations. The presence of PHAs alone or in combination with a bactericidal or bacteriostatic agent would decrease failures of the grafting step, and particularly reduce the mortality of recipient oysters and nucleus rejection by said oysters.

### SUMMARY

The present invention relates to a nucleus covered or coated with a film comprising one or more polyhydroxyalkanoates (PHAs). According to one embodiment of the invention, said PHA is an HB polymer (PHB), an HV polymer (PHV) or HB-HV copolymer (PHB-V).

The present invention also relates to a PHA, characterised in that it is PHB-V type, wherein the HB:HV ratio is greater than or equal to 50:50 and less than 70:30.

The present invention further relates to a composition and a film comprising or consisting of a PHA as described above.

Another object of the invention is a composition or a film comprising a PHA and zosteric acid.

Another object of the invention is a composition or film comprising a PHA and one or more bioactive molecules, chosen among healing or anti-inflammatory agents and bactericidal or bacteriostatic agents, such as for example chemical antibiotics and antimicrobial peptides.

The present invention also relates to the use of a film as described above, for covering a surface, said surface being a pearl farming nucleus or a surface likely to come into contact, preferably in repeated or prolonged contact, with water, such as for example seawater or freshwater, said surface being, for example, the surface of a tank, for example a plastic or metal tank, used in aquaculture, preferably in fish farming, or the substrates and ropes used for oyster farming.

Another object of the invention is thus a surface coated with a film as described above, said surface being preferably a nucleus.

The present invention also relates to a method for protecting surfaces, comprising covering, coating or lining of said surface with a film as described above.

The present invention further relates to a method for obtaining a nucleus as described above, said method comprising a first step consisting in immersing the nucleus in a solution comprising one or more PHAs at a concentration of 0.1 to 10% by weight per volume of the solution, in trifluoroethanol, said first step being optionally followed by a second step consisting in immersing the nucleus in a solution comprising one or more bactericidal or bacteriostatic agents at a concentration of 1 to 10 MIC.

The present invention also relates to a second method for obtaining a nucleus as described above, said method comprising a single step consisting in immersing the nucleus in a solution comprising PHAs at a concentration of 0.05 to 10% by weight per total volume of the solution and one or more bactericidal or bacteriostatic agents at a concentration of 1 to 10 MIC in trifluoroethanol.

Another object of the invention is a third method for obtaining a nucleus as described above, said method comprising a single step consisting in the use of a spray for spraying a composition as described above using a spray on the nucleus.

The present invention thus also relates to a spray comprising or consisting in a composition as described above.

Another object of the invention is an oyster comprising a nucleus as described above or obtained by means of any of the methods according to the invention.

Another object of the invention is a method for grafting a recipient pearl oyster comprising the insertion into the gonad of the recipient pearl oyster of a graft, consisting of the epithelium of the donor oyster mantle, in combination with a nucleus as described above or obtained by any of the methods described above.

The present invention also relates to a method for manufacturing a pearl from a cultured pearl, comprising the grafting method described above.

The present invention further relates to a pearl obtained by methods for manufacturing a pearl as described above, or comprising the nucleus according to the invention, or comprising the film according to the invention under one or more layers of nacre.

Another object of the invention is a method for improving pearl quality and/or reducing the grafting failure of a recipient oyster by a nucleus, said failure corresponding to mortality or rejection of the nucleus by the recipient pearl oyster, and said method comprising grafting of the recipient oyster with a nucleus as described above.

The present invention also relates to the use of the nucleus according to the invention, for reducing grafting failure and/or improving the quality of the pearl obtained.

### DETAILED DESCRIPTION

In pearl farming, pearl production is the result of deposition of nacre on the nucleus inserted into the recipient oyster during the grafting step. The step for grafting the nucleus generally has a high failure rate, due to poor healing of the recipient oyster at the incision made during grafting, or bacterial contaminations. In this way, the nuclei used in pearl farming are increasingly covered with a coating enabling the reduction of the grafting step failure, and ensuring the homogeneity of the surface of the nucleus, resulting in a high-quality pearl.

The present invention thus relates to a nucleus lined or coated with a film comprising one or more polyhydroxyalkanoates (PHAs). According to one embodiment of the invention, the PHA film is continuous around the nucleus. According to one embodiment of the invention, the PHA film has a thickness of 0.1 to 200 μm, preferably of 1 to 100 μm, more preferentially of 5 to 50 μm.

It was clearly demonstrated that some bacteria were capable of synthesising, under controlled conditions, polymers including PHAs (polyhydroxyalkanoates) in response to nutritional imbalance conditions.

Bacterial PHAs are natural polyesters, 100% biodegradable and obtained from renewable resources. These biopolymers are accumulated in bacterial cells under granule form when a nutrient necessary for bacterial growth is limited in the presence of excess carbon substrate. The physicochemical properties of PHAs are dependent on the chemical composition thereof, which is in turn influenced by the nature of the carbon source used for bacterial growth and PHA synthesis. These biopolymers may be produced on an industrial scale and, due to a complex composition specific to each micro-organism, have rheological, physicochemical and biological properties giving said biopolymers applications in numerous industrial sectors. Among these properties, the adhesive and film-forming properties are particularly of note. PHAs also offer the advantage of not being water-soluble.

PHAs are polyester type polymers consisting of the repetition of the following monomeric unit:

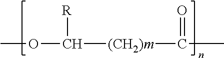

wherein R is an alkyl or alkenyl group of variable size, and m and n are integers, preferably m is equal to 1 or 2, more preferentially m is equal to 1.

PHAs can be divided into 3 classes: PHAscl (short chain length) consisting of hydroxyalkanoic acids having up to 5 carbon atoms, PHAmcl (medium chain length) wherein the monomeric units include 6 to 12 carbon atoms, and PHAlcl (long chain length) wherein the constituent units include 12 to 16 carbon atoms. The former (scl) are rigid and brittle whereas the latter (mcl and lcl) fall under the category of elastomers and adhesives.

According to one embodiment of the invention, the PHAs used in the invention are obtained by fermenting bacteria from microbial mats.

According to one embodiment, said PHAs are synthesised under controlled conditions (nutritional and energy imbalance generated by restricting an element necessary for bacterial growth in the presence of an excess carbon source) when fermenting bacteria from microbial mats. According to one embodiment, these PHAs are chosen from those synthesised by bacteria of the Pyrococcus sp, Vibrio sp, Alteromonas sp, Pseudomonas sp or Pseudoalteromonas sp genus, according to the applicable taxonomy on the date of the present invention. Should the taxonomy be modified, those skilled in the art would be able to adapt the taxonomy modifications in order to deduce the PHAs used in the invention. Advantageously, these bacteria are heterotrophic, aerobic, mesophilic bacteria.

According to one embodiment of the invention, the bacteria producing PHAs used in the invention are cultured for 1 to 5 days, preferably for 2 to 4 days, more preferentially for approximately 3 days on a nitrogen-depleted and carbon source-enriched medium under the following conditions: salinity 35%, temperature 30° C., pH 7.6.

According to one embodiment of the invention, the bacteria culture medium contains one or more carbon sources, of the carbohydrate or fatty acid type. According to one embodiment of the invention, the carbon source(s) is/are selected from the group comprising glucose, glycerol, acetate, benzoate, octanoate, pyruvate, propionate, valerate, and mixtures thereof. According to one embodiment of the invention, the total carbon source concentration in the culture medium varies from 1 to 30 g/l, preferably from 5 to 20 g/l, more preferentially is approximately 10 g/l. According to one embodiment, the nature of the PHA produced by the producing bacteria varies according to the carbon source concentration, the type of carbon source used, and, in the case of a mixture, according to the ratio of the various sources used.

According to one embodiment of the invention, the PHAs used in the invention are extracted from the producing bacteria by means of a method comprising the extraction of the bacterial pellet using organic and/or inorganic, preferentially organic solvents. According to one embodiment of the invention, the PHAs are collected by extraction using a solvent selected in the group comprising chloroform and dichloromethane, followed by precipitation of the PHA polymer in ethanol.

According to one embodiment of the invention, the PHAs used in the invention are short-chain PHAs. Short-chain PHAs consist of hydroxybutyric acid (HB) and/or hydroxyvaleric acid (HV) monomers. Example of short-chain PHAs are PHB (polyhydroxybutyrate), wherein R is CH₃ and m is 1 and PHB-V (poly(hydroxybutyrate-co-hydroxyvalerate), wherein and R is CH₃ or CH₂—CH₃ and m is 1.

According to one embodiment of the invention, the PHA used in the invention is chosen from the group comprising HB polymers (PHB), HV polymers (PHV) and HB-HV copolymers (PHB-V).

Another object of the invention is a PHB-V type PHA, wherein the HB:HV ratio is greater than or equal to 50:50 and less than 70:30. Another object of the invention is that of a PHB-V type PHA, wherein the HB:HV ratio is greater than or equal to 50:50 and less than 65:35. Another object of the invention is a PHB-V type PHA, wherein the HB:HV ratio is greater than or equal to 50:50 and less than 60:40. Another object of the invention is that of a PHB-V type PHA, wherein the HB:HV ratio is greater than or equal to 50:50 and less than 55:45. Another object of the invention is that of a PHB-V type PHA, wherein the HB:HV ratio is equal to 50:50. Another object of the invention is that of a PHB-V type PHA, wherein the HB:HV ratio is equal to 64:36.

According to one embodiment, the PHB-V according to the invention has adhesive and/or film-forming properties.

According to one embodiment of the invention, the PHB-V according to the invention is not water-soluble.

According to one embodiment of the invention, the PHB-V according to the invention is obtained by fermenting bacteria from microbial mats, preferably marine bacteria from microbial mats.

According to one embodiment of the invention, the PHB-V according to the invention is synthesised under controlled conditions (nutritional and energy imbalance generated by restricting an element necessary for bacterial growth in the presence of an excess carbon source) when fermenting bacteria from microbial mats.

According to one embodiment, the PHB-V is chosen from those synthesised by bacteria of the Pyrococcus sp, Vibrio sp, Alteromonas sp, Pseudomonas sp or Pseudoalteromonas sp genus, according to the applicable taxonomy on the date of the present invention. Should the taxonomy be modified, those skilled in the art would be able to adapt the taxonomy modifications in order to deduce the PHB-V according to the invention. Advantageously, these bacteria are heterotrophic, aerobic, mesophilic bacteria.

According to one embodiment of the invention, the bacteria producing the PHB-V according to the invention are cultured on a nitrogen-depleted and carbon source-enriched medium under the following conditions: salinity 35%, temperature 30° C., pH 7.6.

According to the one embodiment of the invention, the PHB-V according to the invention is extracted from the producing bacteria by a method comprising the extraction of the bacterial pellet using organic and/or inorganic, preferentially organic solvents. According to one embodiment of the invention, the PHB-V is collected by extraction using a solvent selected in the group comprising chloroform and dichloromethane, followed by precipitation of the PHA polymer in ethanol.

An object of the invention is a composition comprising or consisting of a PHB-V as described above.

Another object of the invention is a film comprising or consisting of a PHB-V according to the invention. According to one embodiment of the invention, the PHB-V film has a thickness of 0.1 to 200 μm, preferably of 1 to 100 μm, more preferentially of 5 to 50 μm.

Another object of the invention is a film comprising or consisting of a PHB-V according to the invention for covering a surface. According to one embodiment of the invention, said surface is a pearl farming nucleus. According to one embodiment of the invention, said surface is a surface likely to come into contact, preferably in repeated or prolonged contact, with water, such as for example seawater or freshwater. According to this embodiment, said surface may be, for example the surface of a tank, for example a plastic or metal tank, used in aquaculture, preferably in fish farming. According to a further embodiment of the invention, the surfaces covered by a film comprising or consisting of a PHB-V according to the invention are used in pearl farming, such as, for example, the substrates and ropes used for oyster farming.

Another object of the invention is a method for protecting surfaces, comprising covering, coating or lining said surface with a film comprising or consisting of a PHB-V according to the invention. The covering, coating or lining of the surface to be protected would be enable the prevention of the formation of a primary biofilm and subsequently an undesirable bacterial biofilm on said surface. According to one embodiment, said surfaces are chosen from those cited above.

The composition or film of PHB-V according to the invention may be useful for inhibiting bacterial growth. Indeed, PHB and PHB-V are degraded into β-hydroxybutyric acid by the action of the bacterial and fungal depolymerases, by animal tissues or under alkaline or acidic conditions. Various studies have demonstrated that hydroxybutyric acid is a short chain volatile fatty acid, having an inhibitory action on bacterial growth (Van Immerseel, 2003 and Defoirdt, 2007). Short chain volatile fatty acids (of which hydroxybutyric acid) would appear to be capable of passing through the cell membrane of bacteria and dissociating in the alkaline medium of the cytoplasm, thus increasing the intracellular proton concentration. Consequently, bacterial cells would use energy to maintain the intracellular pH thereof at an optimal level. This energy could not be used for other metabolic processes, and cell growth is thus inhibited. Without willing to be bound to any theory, the inventor suggests the hypotheses whereby, once the nucleus has been coated with a film of PHB-V according to the invention introduced into the recipient oyster, the tissues of said oyster would degrade the PHB-V into hydroxybutyric acid, thus inhibiting bacterial growth.

According to one embodiment, the PHA(s), particularly the PHB-V(s) according to the invention, are native. According to another embodiment, the PHA(s), particularly the PHB-V(s) according to the invention may be chemically or physically modified. According to one embodiment of the invention, the PHA used in the invention is modified by adding sulphate, sulphonate, acetate, lactate, succinate, pyruvate groups, or groups modifying the hydrophobic/hydrophilic balance of the resulting PHAs, preferably said groups are selected from the group comprising the epoxide, alcohol, carboxylic acid groups. According to another embodiment of the invention, the PHA used in the invention is modified by depolymerisation to obtain polymers of a lower molecular weight. According to another embodiment of the invention, the PHA used in the invention is modified by grafting a polymer, preferably an oligomer, such as for example an exopolysaccharide (EPS).

It has been demonstrated that some bacteria are capable of synthesising, under controlled conditions, exopolymers including exopolysaccharides (EPS), in response to nutritional imbalance. Exopolysaccharides may be defined as macromolecules formed by series similar carbohydrates (commonly referred to as sugars or oses). These exopolysaccharides may be produced on an industrial scale, and have, among other properties, adhesive (associated with the natural function of these molecules) and film-forming properties.

The EPS may be produced by numerous micro-organisms such as Gram-positive or Gram-negative bacteria, archaea, fungi, and some algae. Advantageously, the EPS are produced by Gram-positive or Gram-negative bacteria, archaea or algae.

The EPS may be extracted from micro-organism cultures by methods of well-known physical or chemical extraction such as, for example, sonication, centrifugation, alkaline treatment, ethanol extraction, enzyme extraction, etc.

According to one embodiment of the invention, the EPS may be chosen among those produced by marine organisms such as Bacillus, Halomonas, Planococcus, Enterobacter, Alteromonas, Pseudoalteromonas, Rhodococcus, Zoogloea, Cyanobacteria, Vibrio, as described in Satpute et al. (Biotechnology Advances 2010, 38: 436-450). Should the taxonomy be modified, those skilled in the art would be able to adapt the taxonomy modifications in order to deduce the EPS suitable for use in the invention.

According to one embodiment of the invention, the EPS may be obtained by fermenting bacteria from deep-sea hydrothermal ecosystems. More particularly, these EPS are those synthesised under controlled conditions (nutritional imbalance generated by a high Carbon/Nitrogen ratio due to a carbohydrate-enriched nutritional medium) when fermenting bacteria from deep-sea hydrothermal ecosystems (see for example Guezennec, J. (2002). Deep-sea hydrothermal vents: A new source of innovative bacterial exopolysaccharides of biotechnological interest? Journal of Industrial Microbiology & Biotechnology 29: 204-208).

According to one embodiment of the invention, the EPS are chosen among HE 800, EPS 721, MO245, GG1, HYD 657, HYD 1644, HYD 1545, GY 785, MS 907, ST 716, HYD 721, GY 772, HYD 750, GY 768, GY 788, B1746, GY 786, GY 685, GY 686, ST 719, HYD 1574, HYD 1579, HYD 1582, HYD 1584, ST 708, ST 722, ST 342, ST 349, HYD 1625, and HYD 1666, preferably MO 245, HE 800, GG1, HYD 721 and ST 716.

According to one embodiment, the EPS are native. According to another embodiment, the EPS may be chemically or physically modified (such as for example by adding sulphate, lactate, succinate or pyruvate group(s)).

Completely unexpectedly, the inventors observed that using a nucleus covered with a film of PHA, preferentially PHB-V according to the invention, decreases the mortality of recipient oysters following grafting. Without willing to be bound to any theory, the inventor suggests that the presence of a film of PHA on the surface of the nucleus modifies the physicochemical properties of the surface, restricting the formation of a primary biofilm and subsequently that of an undesirable bacterial biofilm. The presence of an undesirable biofilm on the surface of the nucleus could result in bacterial contamination of the oyster tissues, and in mortality of said oyster.

Another object of the invention is a composition or a film comprising or consisting of one more PHAs, preferentially one or more PHB-V according to the invention, associated with an agent reinforcing the inhibition of the formation of biofilms of the PHA(s), preferably said agent is zosteric acid. Zosteric acid is described as being suitable for preventing the formation of biofilms on surfaces (U.S. Pat. No. 5,384,176, U.S. Pat. No. 607,741, incorporated by reference).

According to one embodiment of the invention, the association between the film of PHA and the agent(s) described above is the result of an adsorption phenomenon or a chemical reaction between the PHAs and said agents.

According to one embodiment, the zosteric acid is native. According to another embodiment, the zosteric acid may be a chemically modified derivative; preferentially a zosteric acid derivative is a zosteric acid ester as described in US2007/128151, incorporated by reference. According to one preferred embodiment, the zosteric acid derivative is an acid derivative of zosteric acid.

According to one embodiment, the zosteric acid is extracted from the alga Zostera marina.

Another object of the invention is a film comprising or consisting of one or more PHAs, preferably one or more PHB-V according to the invention, associated with an agent reinforcing the inhibition of the formation of biofilms of the PHA(s), preferably zosteric acid for covering a surface.

According to one embodiment, said surface is a nucleus.

According to one embodiment, said surface is a surface likely to come into contact, preferably in repeated or prolonged contact, with water, such as for example seawater or freshwater. According to this embodiment, said surface may be, for example, the surface of a tank, for example a plastic or metal tank, used in aquaculture, preferably in fish farming. According to another embodiment of the invention, the surfaces covered with a film comprising or consisting of a PHB-V according to the invention are used for pearl farming, such as, for example, the substrates and ropes used for oyster farming.

Another object of the invention is a method for protecting surfaces, comprising covering, coating or lining said surface with a film comprising or consisting of one or more PHAs, preferentially one or more PHB-V according to the invention, associated with an agent reinforcing the inhibition of the formation of biofilms of the PHA(s), preferably zosteric acid as described above. The covering, coating or lining of the surface to be protected would enable the prevention of the formation of a primary biofilm and subsequently an undesirable bacterial biofilm on said surface. According to one embodiment, said surfaces are chosen among those cited above.

Another object of the invention is a composition or a film comprising or consisting of one or more PHAs, preferentially one or more PHB-V according to the invention, associated with one or more bioactive molecules.

According to another embodiment of the invention, the association between the film of PHA, preferably one or more PHB-V according to the invention, and the bioactive molecule(s) is the result of an adsorption phenomenon or a chemical reaction between the PHAs and said molecules.

According to one embodiment, these bioactive molecules are healing or anti-inflammatory agents such as collagen, fibrinogen, laminin, or growth factors. In pearl farming, adding a healing or anti-inflammatory agent onto the nucleus could enhance acceleration of the healing of the incision performed while grafting, or to restrict the inflammation thereof, likely to lead to the death of the oyster.

According to another embodiment, these bioactive molecules are bactericidal or bacteriostatic agents. In pearl farming, adding a bactericidal or bacteriostatic agent onto the nucleus would restrict the occurrence of bacterial contaminations in the recipient oyster, likely to lead to the rejection of the nucleus or the death of said oyster.

According to one embodiment of the invention, the bactericidal or bacteriostatic agents are chosen among chemical antibiotics such as for example tetracycline, kanamycin, sulfomonomethoxine, ampicillin.

According to another embodiment of the invention, the bactericidal or bacteriostatic agents are chosen among antimicrobial peptides (AMPs). Antimicrobial peptides (AMPs) are innate immunity effector molecules, preserved over the course of evolution and widespread in the realm of living beings. A wide variety of AMPs have been identified in recent years, revealing a wide diversity in terms of structures, sizes and modes of action. AMPs are generally characterised by a strong representativness of cationic and hydrophobic amino acids. These molecules generally have amphiphilic properties essential for their interaction with bacterial membranes (Bulet et al. 2004). AMPs kill micro-organisms, either by permeabilising the membrane by a detergent effect or by forming pores, either by inhibiting the synthesis of peptidoglycan forming the bacterial wall, or by inhibiting bacterial metabolic pathways (Brodgen 5 et al., 2005).

Compared to the chemical antibiotics generally used, AMPs offer the advantage of being completely biodegradable. They appear to be good candidates for substituting conventional chemical antibiotics, due to the biological properties thereof. Indeed, they offer a broad spectrum of antimicrobial activity, low specificity, various modes of action and safety in respect of the medium.

The AMPs may be produced by chemical synthesis or by expression in a bacterial or yeast recombinant system (cloning, expression, purification). According to one embodiment of the invention, the AMPs are synthesised by chemical synthesis. According to another embodiment of the invention, the AMPs are synthesised by biological synthesis in a bacterial or fungal recombinant system and preferably in a yeast system.

According to one embodiment of the invention, the AMPs may belong to the alpha-helical linear AMP family, to the AMP family having an over-representation of one or more amino acids, to the beta-hairpin AMP family with 1 or 2 disulphide bonds, to the beta-sheet and alpha-helical cyclic AMP family with 3 or more disulphide bonds (Bulet et al., Immunological Reviews, 2004, 198: 169-184; Brogden, Nature Review Microbiology, 2005, 3:238-250).

Examples of alpha-helical linear AMPs include, but are not restricted to, cecropin, stomoxin, ponericin, spinigerin, oxyopinin, cupiennin, clavanin, styelin, pardaxin, misgurin, pleurocidin, parasin, oncorhyncin, moronecidin, magainin, temporin, cathelicidin, indolicidin.

Examples of AMPs enriched with one or more amino acids, proline, arginine, glycine, or tryptophan, include, but are not restricted to, bactenicins, PR-39, abaecins, apidaecins, drosocin, pyrrhocoricins, Cg-Prp, prophenin, indolicin.

Examples of hairpin AMPs containing 2 to 4 cysteines include, but are not restricted to, tachyplesin, protegrin, thanatin, androctonin, gomesin, polyphemusin, hepcidin, brevinin, esculentin, tigerinin or bactenecin.

Examples of cyclic AMPs containing 6 or more cysteine residues or having an open cycle include, but are not restricted to, defensins (of vertebrates, invertebrates or plants), termicin, heliomicin, drosomycin, ASABF, pBD, penaeidins, ALF, big-defensins.

Examples of invertebrate defensins are oyster defensins Cg-Defs or mussel defensins MGD.

According to one embodiment of the invention, the AMP is chosen among tachyplesin and oyster defensins Cg-Defs.

Another object of the invention is a film comprising or consisting of one or more PHAs, preferably one or more PHB-V according to the invention, associated with one or more bioactive molecules, as described above for covering a surface.

According to one embodiment, said surface is a nucleus.

According to another embodiment of the invention, said surface is a surface likely to come into contact, preferably in repeated or prolonged contact, with water, such as for example seawater or freshwater. According to this embodiment, said surface may be, for example the surface of a tank, for example a plastic or metal tank, used in aquaculture, preferably in fish farming. According to another embodiment of the invention, the surfaces covered by a film comprising or consisting of a PHB-V according to the invention are used in pearl farming, such as, for example, the substrates and ropes used for oyster farming.

According to one embodiment of the invention, the film comprising PHAs, preferentially PHB-V according to the invention, optionally associated with bioactive molecules or with an agent reinforcing the inhibition of the formation of biofilms of the PHA(s), preferably zosteric acid, is resistant to washing with seawater and is stable for more than 3 weeks, preferentially more than one month, more preferentially more than 6 months at temperatures varying between 4 and 30° C. In this way, the film according to the invention is not dissolved when in contact with seawater, for at least 3 weeks.

The present invention also relates to a method for obtaining a nucleus lined or coated with a film comprising one or more polyhydroxyalkanoates (PHAs), preferably the PHB-V according to the invention, said film might be associated with bioactive molecules or with an agent reinforcing the inhibition of the formation of biofilms of the PHA(s), preferably zosteric acid, as described above.

According to one embodiment of the invention, the method according to the invention comprises a first step consisting of coating the nucleus with the film of PHA, preferably with the film of PHB-V according to the invention, optionally followed by a second step consisting in associating the film of PHA formed with one or more other molecules, as described above.

According to one embodiment of the invention, said method comprises a first step of immersing the nucleus in a solution comprising one or more PHAs, preferably one or more PHB-V according to the invention, in trifluoroethanol (CF₃CH₂OH, TFE). According to one preferred embodiment of the invention, said PHA solution has a PHA concentration of 0.1 to 10% weight/volume, more preferentially of 0.5 to 5%, even more preferentially of 1% by weight of PHA per volume of TFE solution.

According to one embodiment of the invention, said first step of immersing the nucleus in a solution containing one or more PHAs is performed at a constant temperature, preferentially at room temperature (i.e. from 15 to 25° C.), more preferentially approximately 20° C. According to this embodiment of the invention, said first step of immersing the nucleus in a solution containing one or more PHAs is performed preferentially for 10 minutes to 3 hours, more preferentially for 20 minutes to 1 hour, even more preferentially for approximately 30 minutes.

According to another embodiment of the invention, said first step of immersing the nucleus in a solution containing one or more PHAs is performed at a constant temperature, preferentially from 1 to 10° C., more preferentially approximately 4° C. According to this embodiment of the invention, said first step of immersing the material in a solution containing one or more PHAs is performed preferentially for 10 minutes to 3 hours, more preferentially for 20 minutes to 1 hour, even more preferentially for approximately 30 minutes.

According to one embodiment of the invention, the coated nucleus is then vacuum-dried.

If the film coating the nucleus also comprises one or more other molecules, such as zosteric acid, or a bioactive molecule, such as, for example, a bactericidal or bacteriostatic agent, the first step described above is followed by a second step of associating said molecules. According to one embodiment of the invention, if said molecules are bactericidal or bacteriostatic, the second step comprises the immersion of the nucleus coated with a film of PHA in a solution comprising one or more bactericidal or bacteriostatic agents at a concentration of 1 to 10 MIC.

According to the invention, the bactericidal or bacteriostatic agent is in solution in a biologically acceptable polar solvent such as water, ethanol, TFE or the mixture thereof such as for example water/TFE, preferably trifluoroethanol (CF₃CH₂OH).

According to one embodiment of the invention, the second step of immersing the nucleus is performed at a constant temperature, preferentially from 1 to 10° C., more preferentially approximately 4° C.

According to one embodiment of the invention, said second step of immersing the nucleus is performed preferentially for 1 to 120 hours, more preferentially for 12 to 96 hours, even more preferentially for 24 to 72 hours.

According to one embodiment of the invention, the coated nucleus is then vacuum-dried.

According to one embodiment of the invention, said method optionally comprises a step to rinse the nucleus between the first immersion step and the second immersion step. According to this embodiment, the nucleus is rinsed with a volume of 10 to 1000 ml of distilled water, preferentially 100 to 300 ml of distilled water, more preferentially approximately 200 ml of distilled water.

The invention also relates to a method for obtaining a nucleus coated with a film comprising one or more PHAs, preferably with one or more PHB-V according to the invention, and one or more other molecules, such as for example one or more biomolecules, for example one or more bacteriostatic or bactericidal agents, said method comprising a single step of immersing the nucleus in a solution comprising PHAs and bacteriostatic or bactericidal agents, in TFE.

According to one embodiment, the PHAs are present in the solution at a concentration of 0.05 to 10% by weight per total volume of the solution, preferentially of 0.1 to 5%, more preferentially at a concentration of 1%.

According to one embodiment, the bactericidal or bacteriostatic agents are present in the solution at a concentration of 1 to 10 MIC.

According to one embodiment, this immersion step is performed at a constant temperature, of 1 to 10° C., preferentially 4° C., and for 1 to 128 hours, preferentially for 12 to 96 hours, and more preferentially for 24 to 72 hours.

The present invention also relates to a method for coating a nucleus with a film comprising one or more PHAs, preferably one or more PHB-V according to the invention, optionally in association with one or more other molecules chosen among the group comprising agents reinforcing the action for inhibiting the formation of PHA biofilms, preferably zosteric acid and bioactive molecules, such as healing or anti-inflammatory agents, and bacteriostatic or bactericidal agents, preferably AMPs, comprising the use of a spray for spraying the composition according to the invention on the surface of the nucleus.

The present invention relates to a spray comprising or consisting of PHAs, preferably comprising or consisting of PHB-V according to the invention.

The present invention relates to a spray comprising or consisting of one or more PHAs, preferably one or more PHB-V according to the invention in association with one or more molecules chosen among the group comprising agents reinforcing the action for inhibiting the formation of PHA biofilms, preferably zosteric acid and bioactive molecules, such as healing or anti-inflammatory agents, and bacteriostatic or bactericidal agents, preferably AMPs.

According to one embodiment of the invention, the nucleus is of natural origin, more preferentially said nucleus is made of nacre from Mississippi mussels belonging to the Ambelema sp. genus, preferably Amblema plicata. Examples of nuclei are those sold by Aming (Standard Aming) or by Poe Import.

According to one embodiment of the invention, said nucleus has a diameter of 1 to 20 mm, preferentially of 2 to 15 mm, more preferentially of 2 to 4 mm, and even more preferentially of 2.1 to 3.5 mm.

According to one embodiment of the invention, said nucleus has a diameter of 2 to 2.5 BU, preferably approximately 2.4 BU. The BU is a unit of measurements, where 1 BU is equivalent to 3.03 mm.

The invention also relates to an oyster comprising a nucleus as described above or obtained by a method as described above. Preferably, the oyster belongs to the Pinctada sp. genus, more preferentially, to the Pinctada fucata, Pinctada maxima, Pinctada margaritifera species.

The present invention also relates to a method for grafting a recipient pearl oyster, preferably belonging to the genera and species cited above, with a nucleus lined or coated with a film of PHA, preferably PHB-V, optionally associated with zosteric acid or with a bioactive molecule, as described above. FIG. 1A shows the various grafting steps. According to one embodiment of the invention, the grafting method comprises opening manually the recipient pearl oyster, performing an incision in the tissues of the recipient pearl oyster, accessing the gonad and enabling, in a third step, the insertion, in the gonad of the recipient pearl oyster, of a graft, consisting of a portion of the epithelium of the donor oyster mantle (approximately 4 mm²), in conjunction with a nucleus coated or covered with a film of PHA, preferably PHB-V, as described above.

The present invention also relates to a method for producing or manufacturing a cultured pearl, comprising a step for grafting a recipient pearl oyster with a nucleus, according to the method described above.

The present invention also relates to a method for obtaining pearls comprising the use of the coated nucleus as described above, or obtained according to a coating method as described above.

According to one embodiment of the invention, the method for obtaining pearls comprises grafting a nucleus according to the invention in the gonad of a recipient oyster, in conjunction with a portion of the epithelium of a donor oyster mantle.

According to one embodiment of the invention, said method for producing, manufacturing or obtaining pearls comprises a first step comprising the collection and breeding of pearl oysters, preferably belonging to the genera and species cited above, for obtaining donor pearl oysters and recipient pearl oysters.

According to one embodiment of the invention, the donor or recipient pearl oysters are then cleaned to remove any parasites.

According to one embodiment of the invention, said method for producing, manufacturing or obtaining pearls further comprises, following grafting, a step for cultivating the recipient pearl oysters, preferably for a period of 10 to 24 months, preferably from 12 to 20 months, more preferentially from 16 to 18 months. For the cultivation period, the epithelial lining of the graft multiplies and lines the gonad to produce the pearl sac coating the nucleus, subsequently depositing layers of nacre around the nucleus, resulting in the production of a pearl (FIG. 1B).

The present invention also relates to the pearl obtained by the method as described above.

The invention also relates to a pearl comprising a covered nucleus according to the invention, or a nucleus obtained by a method according to the invention.

The present invention also relates to a pearl wherein the nucleus is covered with a film of PHA, optionally in association with one or more molecules chosen among the group comprising agents reinforcing the action for inhibiting the formation of PHA biofilms, preferably zosteric acid and bioactive molecules, such as healing or anti-inflammatory agents, and bacteriostatic or bactericidal agents, preferably AMPs.

The present invention also relates to a pearl comprising a film of PHA, preferably PHB-V according to the invention, optionally in association with one or more molecules chosen among the group comprising agents reinforcing the action for inhibiting the formation of PHA biofilms, preferably zosteric acid and bioactive molecules, such as healing or anti-inflammatory agents, and bacteriostatic or bactericidal agents, preferably AMPs, under one or more layers of nacre.

According to one embodiment of the invention, the pearl has a size, preferably a diameter of 2 to 20 mm, preferably of 5 to 15 mm, more preferentially of 6.8 to 10 mm.

Surprisingly, the applicant observed that coating the nucleus with a film of PHA, preferably PHB-V according to the invention, optionally associated with one or more molecules chosen among the group comprising agents reinforcing the action for inhibiting the formation of PHA biofilms, preferably zosteric acid and bioactive molecules reduces the failure rate of the grafting operations. In this way, using a coating nucleus according to the invention reduces the recipient oyster mortality rate within 30 days post-graft and increases the nucleus maintenance rate in the recipient oyster (Example 3). Without willing to be bound to any theory, the inventors suggest that coating the nucleus with said film would reduce bacterial contaminations in the recipient oyster. Furthermore, associating said film of PHA with bactericidal or bacteriostatic agents, such as for example antimicrobial peptides (AMPs), would reduce the occurrence of microbial contaminations further. The presence of PHAs, preferably PHB-V according to the invention, alone or in conjunction with a bactericidal or bacteriostatic agent would thus reduce failures of the grafting step, and particularly reducing the mortality of recipient oysters and nucleus rejection by said oysters.

The present invention thus also relates to a method for reducing failure in respect of grafting a recipient oyster with a nucleus, said failure consisting of mortality or rejection of the nucleus by the recipient pearl oyster, and said method comprising grafting of the recipient oyster with a nucleus coated or covered with PHA, preferably PHB-V according to the invention, as described above.

The present invention also relates to the use of a nucleus coated or covered with PHA, preferably PHB-V as described above, for reducing failure in respect of grafting a recipient oyster with a nucleus, said failure consisting of mortality or rejection of the nucleus by the recipient pearl oyster.

The present invention also relates to a method for inhibiting rejection of the nucleus during grafting, said method comprising the use of a coated nucleus according to the invention during grafting.

The present invention further relates to a method for reducing the mortality of recipient oysters following the grafting step, comprising the use of a coated nucleus according to the invention during grafting. According to one embodiment of the invention, the mortality prevented by the method according to the invention is due to an infection of the incision performed while grafting.

Coating pearl farming nuclei with a film of PHA, preferably PHB-V, optionally associated with one or more molecules chosen among the group comprising agents reinforcing the action for inhibiting the formation of PHA biofilms, preferably zosteric acid and bioactive molecules, as described above would improve the homogeneity of the nucleus surface, and thus improve the quality of the pearl obtained by restricting the appearance of surface defects.

The present invention also relates to a method for improving the homogeneity of a nucleus, comprising coating said nucleus with a film as described in the present invention.

The present invention thus also relates to a method for improving the quality of the pearl obtained following grafting of the recipient pearl oyster, said method comprising the use of a nucleus coated or covered with PHA, preferably PHB-V, as described above.

The present invention also relates to the use of a nucleus coated or covered with PHA, preferably PHB-V, as described above for improving the quality of the pearl obtained.

### DEFINITIONS

The term “nucleus” denotes an element, which is generally spherical, constituted of a natural compound (for example nacre from Mississippi mussels, Amblema plicata) or synthetic compound (for example made of Bironite) introduced into the recipient oyster during the grafting step, and serving a substrate for nacre deposition by the recipient pearl oyster. Said nucleus may be coated with particular substances for improving the quality of the pearl obtained.

The term “pearl farming” denotes a human activity intended to produce cultured pearls using pearl oysters, generally belonging to the Pinctada sp. genus.

The term “bactericidal agent” denotes a substance having a bactericidal action, i.e. inducing the death of bacteria.

The term “bacteriostatic agent” denotes a substance having a bacteriostatic action, i.e. blocking the development, growth and/or division of bacteria.

The term “primary film” denotes a conditioning film consisting of proteins or protein fragments, carbohydrates, lipids, mineral materials such as for example mineral salts, from the surrounding medium. This primary film stimulates bacterial adhesion.

The term “undesirable biofilm” denotes a film of micro-organisms, generally bacteria, adhering to the primary film, in a first reversible then irreversible adhesion step.

The term “MIC” denotes the minimum concentration from which an agent inhibits the visible growth of a micro-organism after incubating overnight. The methods for determining the MIC of an agent are well-known in the prior art.

The term “aquaculture” denotes the set of human animal and plant production activities in an aquatic environment, particularly in a marine, river or pond aquatic environment. Aquaculture particularly relates to the production of fish (this is referred to as fish farming), shellfish (shellfish farming or pearl farming in particular), crustaceans (crayfish farming and prawn farming in particular), or algae (seaweed farming).

The term “nacre” denotes a biomineralised structure formed from aragonite crystals (consisting of almost 90% nacre) and conchyolin; where aragonite is a chemical compound having the formula CaCO₃+traces of Sr; Pb; Zn.

### BRIEF DESCRIPTION OF THE FIGURES

FIG. 1 is a diagram showing various steps of the graft and the pearl formation. A: Grafting. B: Formation of the pearl sac and the pearl in the gonad (Illustration C. Montagnani).

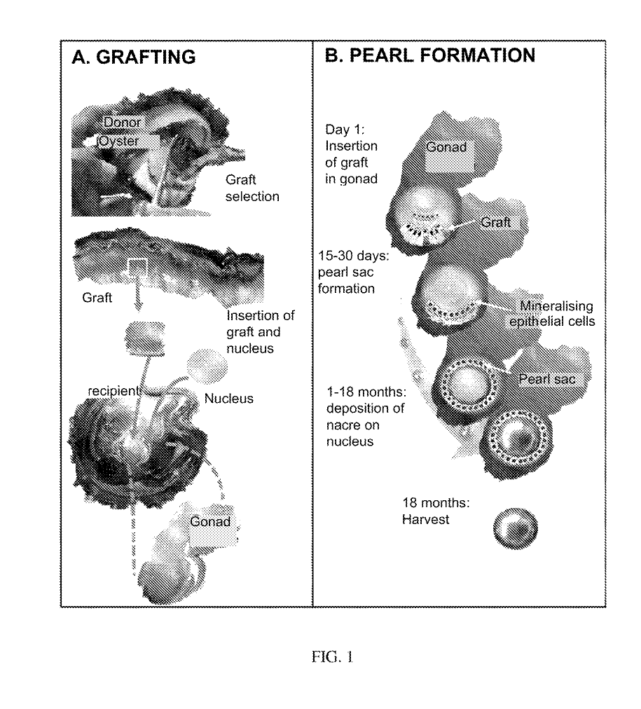

FIG. 2 is an assembly of photos obtained by scanning microscopy, of uncoated (a) and coated (b and c) nuclei. The marks consist of voluntary tears to confirm the presence of the film.

The examples hereinafter show particular embodiments of the invention, illustrating the invention in a non-limiting manner.

### EXAMPLES

### Example 1

### Presence of PHA Film

Nuclei were covered with a film comprising bacterial PHB-V FAK1402. FAK1402 is a PHB-V type PHA wherein the HB:HV is equal to 64:36. These nuclei were obtained by immersion for 10 min at a constant temperature of 20° C. in a TFE solvent supplemented with FAK1402 resulting from biotechnological fermentation methods at a concentration of 1% weight/volume, followed by vacuum-drying.

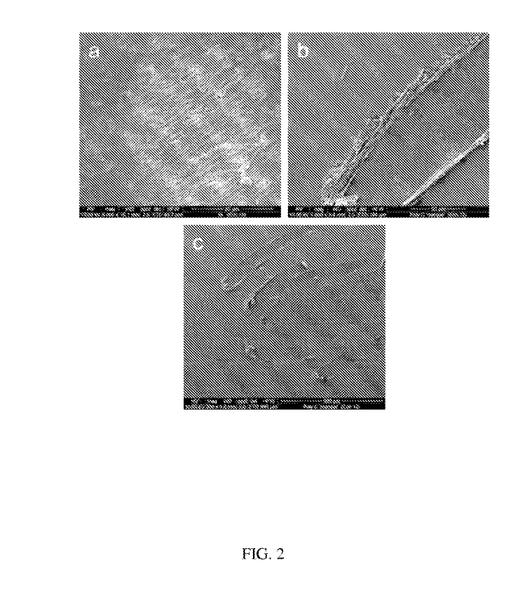

FIG. 2 obtained by scanning microscopy clearly demonstrates the presence of a film. Figure a shows an uncoated nucleus. Figure b and c show the presence of the film following a tear, without washing and after washing with water, respectively.

### Example 2

### Antimicrobial Activity

### Experiments:

Nuclei having a standard diameter were used for studies relating to the influence of a pre-treatment of surfaces with a film of PHA of bacterial origin.

The nuclei were covered with a film comprising PHB-V FAK1402 alone or in conjunction with tachyplesin (AMP).

These nuclei are obtained by a two-step method:
immersing for 10 min at a constant temperature of 20° C. in a TFE solvent supplemented with FAK1402 resulting from biotechnological fermentation methods at a concentration of 1% weight/volume, followed by vacuum-drying;
(optionally) immersing the nuclei coated with the film of PHA in a solution comprising 10 MIC (i.e. 70 mg/l) of tachyplesin, followed by vacuum-drying.

A conventional bacterial growth inhibition test was performed on these nuclei: the nuclei were placed in contact with the bacterial solution in the exponential growth phase of the Vibrio strain isolated from Pinctada margaritifera following grafting in Tahiti for 18 hours at 30° C. The bacterial solution is then smeared on a Petri dish (Zobell Agar medium) and the colonies developed are then counted. Uncoated nuclei are used as negative controls.

Results:

Nuclei uncoated or coated with a film of polyhydroxyalkanoate FAK1402 alone did not demonstrate an inhibitory effect on bacterial growth. However, nuclei coated with an antimicrobial peptide associated with a film of polyhydroxyalkanoate FAK1402 displayed bactericidal activity.

### Example 3

### Efficacy of the Nuclei According to the Invention in Grafting Experiments

### 1. Mortality

Nuclei uncoated or coated with a PHA according to the invention (PHB-V wherein the HB:HV ratio is equal to 64:36), alone or in conjunction with an AMP (tachyplesin) were grafted on recipient oysters in conjunction with a portion of the epithelium of the mantle of a recipient oyster (graft). 64 donor oysters were used for this experiment. 8 grafting experiments were performed per nucleus type and per donor.

The mortality of the recipient oyster was assessed 30 days post-graft as a percentage in relation to the oysters receiving an uncoated nucleus. The results are shown in the following table:

| Condition | Relative mortality (%) |
|---|---|
| Uncoated nucleus | 100% |
| Nucleus coated with a PHA | 82.3% |
| Nucleus coated with a PHA and tachyplesin | 70.8% |

The presence of the film of PHA or PHA+AMP inhibits oyster mortality by almost 20% and 30%, respectively.

### 2. Grafting Maintenance

Nuclei uncoated or coated with a PHA according to the invention (PHB-V wherein the HB:HV ratio is equal to 64:36), alone or in conjunction with an AMP (tachyplesin) were used in grafting experiments as described above.

The maintenance of the nuclei 30 days post-graft was measured. The results are given in the following table, and are expressed in relation to the oysters receiving an uncoated nucleus.

| Condition | Relative mortality (%) |
|---|---|
| Uncoated nucleus | 100% |
| Nucleus coated with a PHA | 106.4% |
| Nucleus coated with a PHA and tachyplesin | 107.4% |

The presence of the film of PHA or PHA+AMP increases the maintenance of the nuclei in the recipient oyster by more than 6.5%.

1-20. (canceled)

21. Nucleus coated with a film comprising one or more polyhydroxalkanoates (PHAs).

22. Nucleus according to claim 21, wherein said PHA is an HB polymer (PHB), an HV polymer (PHV) or HB-HV copolymer (PHB-V).

23. PHA, characterised in that it is a PHB-V type, wherein the HB:HV ratio is greater than or equal to 50:50 and less than 70:30.

24. Composition comprising or consisting of a PHA according to claim 23.

25. Film comprising or consisting of a PHA according to claim 23.

26. Composition or film comprising a PHA and zosteric acid.

27. Composition or film comprising a PHA and one or more bioactive molecules, chosen among healing or anti-inflammatory agents and bactericidal or bacteriostatic agents.

28. Composition or film according to claim 27, wherein the bactericidal or bacteriostatic agents are chemical antibiotics and antimicrobial peptides.

29. A method for covering a surface, said surface being a pearl farming nucleus or a surface likely to come into contact with water, comprising covering said surface with a film comprising or consisting of a PHA according to claim 23.

30. The method according to claim 29, wherein the film further comprises zosteric acid.

31. The method according to claim 29, wherein the film further comprises one or more bioactive molecules, chosen among healing or anti-inflammatory agents and bactericidal or bacteriostatic agents.

32. The method according to claim 29, wherein the surface likely to come into contact with water is in repeated or prolonged contact with seawater or freshwater.

33. The method according to claim 29, wherein the surface likely to come into contact with water is the surface of a tank used in aquaculture or the substrates and ropes used for oyster farming.

34. Surface covered with a film according to claim 23.

35. A method for protecting a surface, comprising covering, coating or lining said surface with a film according to claim 23.

36. A method for obtaining a nucleus according to claim 21, comprising a first step of immersing the nucleus in a solution comprising one or more PHAs at a concentration of 0.1 to 10% by weight per volume of the solution, in trifluoroethanol, said first step being optionally followed by a second step consisting in immersing the nucleus in a solution comprising one or more bactericidal or bacteriostatic agents at a concentration of 1 to 10 MIC.

37. A method for obtaining a nucleus according to claim 21, comprising a single step of immersing the nucleus in a solution comprising PHA at a concentration of 0.05 to 10% by weight per total volume of the solution and one or more bactericidal or bacteriostatic agents at a concentration of 1 to 10 MIC in trifluoroethanol.

38. A method for obtaining a nucleus according to claim 21, comprising a single step of spraying on the nucleus a composition comprising or consisting of a PHA, wherein the PHA is a PHB-V type, wherein the HB:HV ratio is greater than or equal to 50:50 and less than 70:30.

39. Spray comprising or consisting of a composition according to claim 23.

40. Oyster comprising a nucleus according to claim 21.

41. A method for grafting a recipient pearl oyster comprising the insertion into the gonad of the recipient pearl oyster of a graft consisting of the epithelium of the donor oyster mantlein conjunction with a nucleus according to claim 21.

42. A method for manufacturing a cultured pearl, comprising the method according to claim 41.

43. Pearl comprising a film under one or more layers of nacre, said film comprising or consisting of a PHA, wherein the PHA is a PHB-V type, wherein the HB:HV ratio is greater than or equal to 50:50 and less than 70:30.

44. A method for improving pearl quality and/or reducing the failure in respect of grafting a recipient oyster with a nucleus, said failure consisting of mortality or rejection of the nucleus by the recipient pearl oyster, and said method comprising grafting of the recipient oyster with a nucleus according to claim 21.
